(19) United States
(12) Patent Application Publication
(10) Pub. No.: US 2025/0251883 A1
(43) Pub. Date: Aug. 7, 2025

(54) STORAGE MEDIUM STORING PRINT APPLICATION, INFORMATION PROCESSING APPARATUS, AND CONTROL METHOD FOR INFORMATION PROCESSING APPARATUS

(71) Applicant: CANON KABUSHIKI KAISHA, Tokyo (JP)

(72) Inventor: DAICHI HIDAKA, Tokyo (JP)

(21) Appl. No.: 19/021,674

(22) Filed: Jan. 15, 2025

(30) Foreign Application Priority Data
Feb. 2, 2024 (JP) 2024-014879

(51) Int. Cl. G06F 3/12

(52) U.S. Cl. CPC G06F 3/1225; G06F 3/1203; G06F 3/1228; G06F 3/1232

(57) ABSTRACT

A storage medium storing a print application that can execute a function, among functions executable by a printing apparatus, that cannot be executed by using a common printer driver that can be used in common by printing apparatuses of different venders in printing. A print application that can execute a print instruction, and is used together with a standard driver capable of transmitting print data to printing apparatuses of manufacturers, an expansion application, and an operating system controlling the standard driver, the expansion application, and the print application. The print application includes obtaining function information regarding a printer driver inexecutable function that the standard driver cannot cause a printing apparatus to execute, among functions executable by the printing apparatus, from the expansion application, and instructing the operating system to cause the printing apparatus to execute the printer driver inexecutable function based on the function information by the expansion function.

### BACKGROUND OF THE INVENTION

### Field of the Invention

The present invention relates to a storage medium storing a print application, an information processing apparatus, and a control method for the information processing apparatus.

### Description of the Related Art

A host computer (an information processing apparatus) capable of

processing information is communicably connected to a printing apparatus. As control software for controlling the printing apparatus, for example, a printer driver installed in the host computer from the printing apparatus is used. The printer driver enables the host computer to issue a print instruction to the printing apparatus. An operating system (hereinafter referred to as “OS”), which is basic software, is installed in the host computer in advance. The printer driver has a configuration conforming to the specifications defined by the OS, and can be called by the OS to operate. Further, such a printer driver depends on each vendor supplying a printing apparatus, that is, a printer driver is unique and suitable to a model of each printing apparatus.

In recent years, Windows (registered trademark) provides a standard class driver (hereinafter, may be referred to as a “standard driver” or a “common printer driver”) that can be used in common in printing apparatuses supplied by different vendors. Such a common printer driver is incorporated in the OS in advance. Then, when an arbitrary printing apparatus is connected to a host computer having an OS in which the common printer driver is incorporated, the common printer driver can be used. This is able to omit installation of the printer driver unique and suitable to the model. The common printer driver can designate and use a print function of the printing apparatus in accordance with Print Device Capabilities (hereinafter referred to as “PDC”) generated on the basis of information obtained from the printing apparatus. Thus, the print function can be designated for each printing apparatus by one common printer driver.

Japanese Patent Laid-Open Publication No. 2018-101303 (JP2018-101303A) discloses an information processing apparatus constituting a print control server. The information processing apparatus includes a print control application constructed by a first architecture (for example, 32 bits) and an operation system of a second architecture (for example, 64 bits version OS) capable of executing the program of the first architecture. The information processing apparatus also includes a storage device that stores print setting information (Devmode information) used for printing. In the information processing apparatus, the print control application can request to change a print setting by the Devmode information.

Although the printing apparatus has a plurality of executable functions, these functions may include a function that the information processing apparatus described in the above publication cannot be instruct the printing apparatus to execute.

### SUMMARY OF THE INVENTION

The present invention provides a storage medium storing a print application, an information processing apparatus, and a control method for the information processing apparatus that can execute a function, among functions executable by a printing apparatus, that cannot be executed by using a common printer driver that can be used in common by printing apparatuses of different venders in printing.

Accordingly, an aspect of the present invention provides a non-transitory computer-readable storage medium storing a print application that can execute a print instruction, and is used together with a standard driver capable of transmitting print data to printing apparatuses of manufacturers, an expansion application, and an operating system controlling the standard driver, the expansion application, and the print application. The print application includes obtaining function information regarding a printer driver inexecutable function that the standard driver cannot cause a printing apparatus to execute, among functions executable by the printing apparatus, from the expansion application, and instructing the operating system to cause the printing apparatus to execute the printer driver inexecutable function based on the function information by the expansion function.

According to the present invention, it is possible to cause the printing apparatus to execute a function, among functions executable by a printing apparatus, that cannot be executed by using the common printer driver that can be used in common by printing apparatuses of different venders in printing.

Further features of the present invention will become apparent from the following description of exemplary embodiments with reference to the attached drawings.

### BRIEF DESCRIPTION OF THE DRAWINGS

FIG. 1 is a block diagram showing a hardware configuration of a print system.

FIGS. 2A and 2B are block diagrams showing software configurations of the print system.

FIG. 3 is a view showing an example of print function information generated by print data generation software.

FIGS. 4A, 4B, and 4C are views showing examples of print setting screens displayed by a print-setting-screen expansion unit.

FIG. 5 is a sequence chart showing a process (a printer driver inexecutable function execution process) executed between a drawing application, an OS, and an expansion application.

FIG. 6 is a flowchart showing a process performed by the drawing application in the sequence chart shown in FIG. 5.

FIG. 7 is a flowchart showing a process (a process for transmitting a list of printer driver inexecutable functions) executed by an external function providing unit of the expansion application in the sequence chart shown in FIG. 5.

FIG. 8 is a view showing an example of a list of the printer driver inexecutable functions.

FIG. 9 is a flowchart showing a process (a process for executing a printer driver inexecutable function) executed by the external function providing unit of the expansion application in the sequence chart shown in FIG. 5.

FIGS. 10A to 10F are views showing examples of commands executed by the drawing application, the OS, and the expansion application, respectively.

FIG. 11 is a view showing an example of prohibition information held by the expansion application.

FIG. 12 is a view showing an example of a print setting screen used in the drawing application.

FIG. 13 is a view showing a state where a prohibition cancellation process is executed on the print setting screen shown in FIG. 12.

FIG. 14 is a view showing an example of a utility screen.

FIGS. 15A to 15D are views showing examples displaying maintenance execution results.

FIG. 16 is a view showing an example of print function information generated by a print function expansion unit.

### DESCRIPTION OF THE EMBODIMENTS

Hereafter, embodiments according to the present invention will be described in detail by referring to the drawings. However, the configurations described in the following embodiments are merely examples, and the scope of the present invention is not limited by the configurations described in the embodiments. For example, each unit constituting the present invention can be replaced with any configuration capable of exhibiting the same function. In addition, an arbitrary constituent may be added. In addition, two or more arbitrary configurations (features) of the embodiments can be combined.

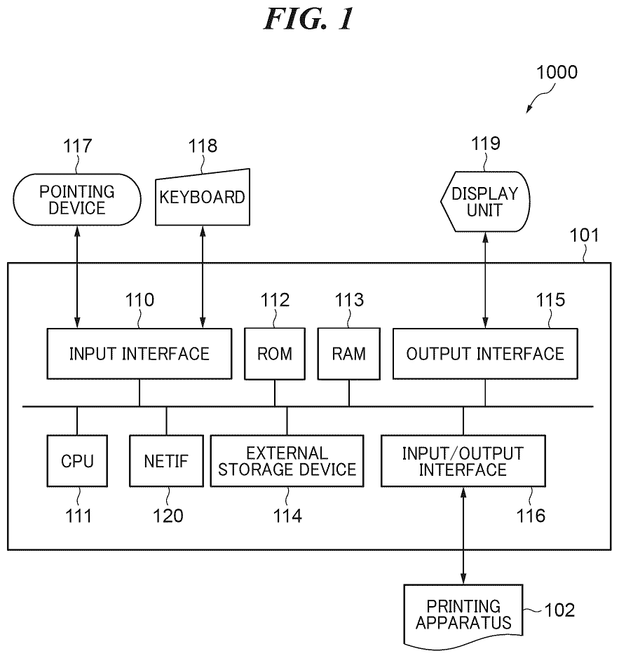

FIG. 1 is a block diagram showing a hardware configuration of a print system. As shown in FIG. 1, the print system 1000 includes a host computer 101, a printing apparatus 102, a keyboard 118, a pointing device 117, and a display unit 119, which are mutually connected to be communicable. The host computer 101 is an information processing apparatus and has an input interface 110, a CPU 111, a ROM 112, a RAM 113, an external storage device (a recording medium) 114, an output interface 115, an input/output interface 116, and a NETIF 120. As the host computer 101, for example, a desktop personal computer can be used, but this is not limiting, and for example, a notebook personal computer, a tablet terminal, a smartphone, or the like can also be used.

The CPU 111 executes programs stored in the ROM 112 and/or the external storage device 114. The programs include a program for causing the CPU 111 to achieve each unit or each means (a control method for the information processing apparatus) of the host computer 101. An initialization program is stored in the ROM 112.

The external storage device 114 stores an application program group, an Operating System (OS) 213, print data generation software 202, and various data. In this embodiment, Windows (registered trademark) 11 of Microsoft (registered trademark) is installed in the host computer 101 as the OS 213.

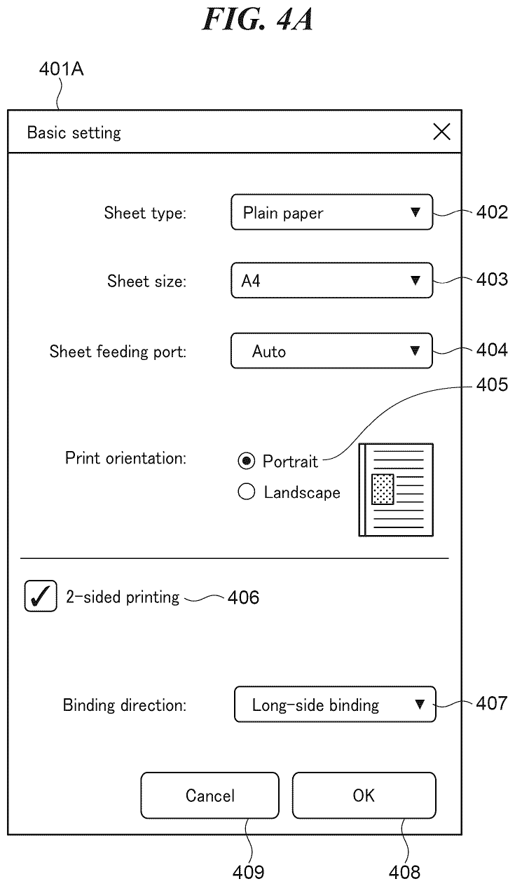

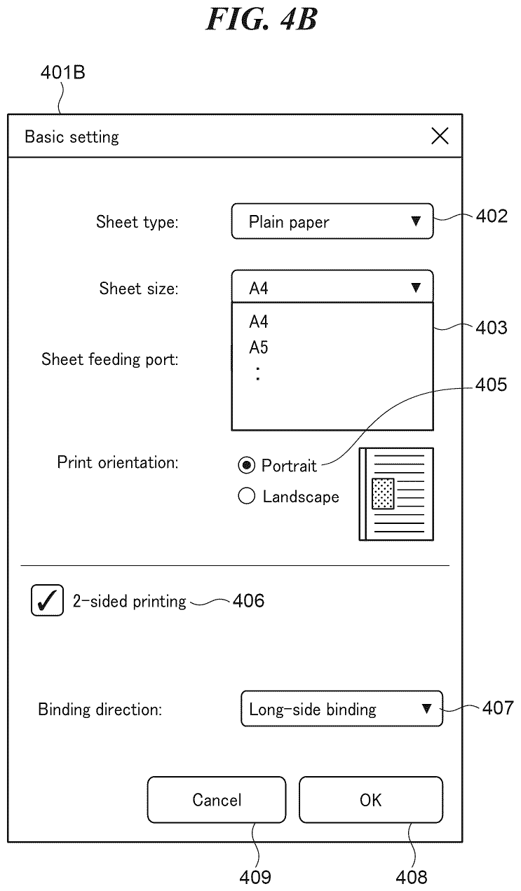

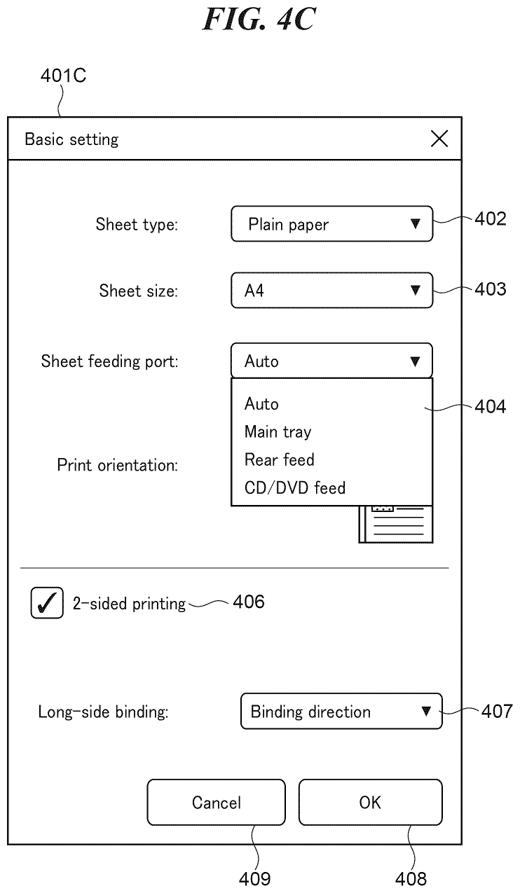

The RAM 113 is used as a work memory when various programs stored in the external storage device 114 are executed, which allows operations of the various programs in the host computer 101. The pointing device 117 and the keyboard 118 as the input devices are connected to the input interface 110. The display unit 119 as a display device is connected to the output interface 115. For example, a print setting screen 400A (see FIG. 4) for setting a print condition is displayed on the display unit 119.

The NETIF 120 is a network interface and controls data transfers to and from an external apparatus via a network. The printing apparatus 102 is connected to the input/output interface 116. The host computer 101 can communicate with the printing apparatus 102 regardless of a manufacturer of the printing apparatus 102, that is, can process information with a plurality of printing apparatuses of a plurality of manufacturers.

As the printing apparatus 102, for example, a multi-function peripheral (MFP) having a plurality of functions, such as copying, printing, and FAX, can be used, but this is not limiting. In addition, the printing apparatus 102 employs an electrophotographic system in this embodiment, but this is not limiting, and may employ an inkjet system, for example. Although the host computer 101 and the printing apparatus 102 are configured as separate apparatuses in this embodiment, this is not limiting. For example, the host computer 101 and the printing apparatus 102 may be configured as an integrated apparatus.

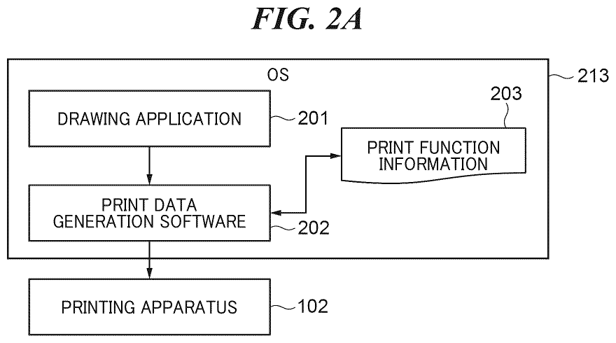

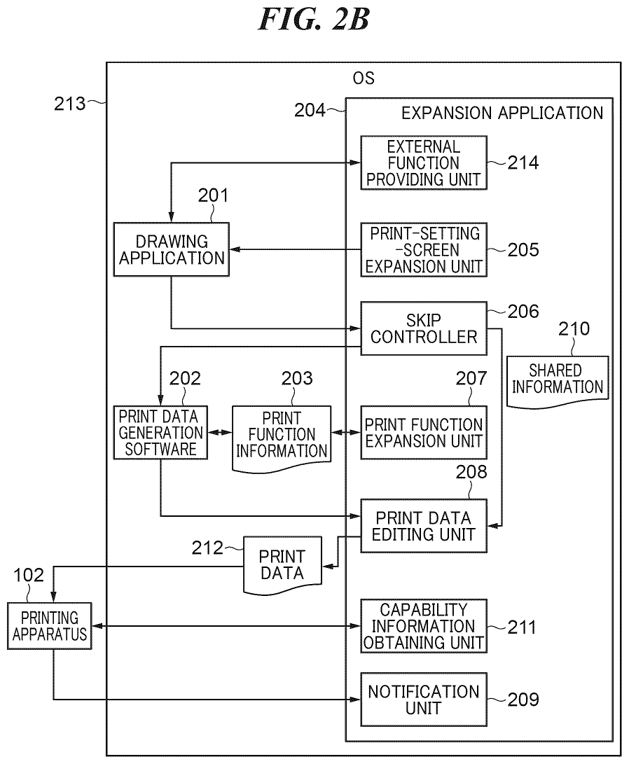

FIGS. 2A and 2B are block diagrams showing software configurations of the print system. FIG. 2A shows a general configuration in which an expansion application 204 is not associated with the print data generation software 202 and the printing apparatus 102. FIG. 2B is the view showing a configuration in which the expansion application 204 is associated with the print data generation software 202 and the printing apparatus 102.

The print data generation software 202 is a common printer driver (program) that can be used in common for the printing apparatuses of a plurality of manufacturers in printing, that is, a standard class driver (standard driver), and is installed in the OS 213 in advance. As the print data generation software 202, a program that operates on the basis of an IPP (Internet Printing Protocol), which is a standard printing protocol, is used.

The expansion application 204 is an expanded program that can expand a function of the print data generation software 202. The expansion application 204 is stored in the external storage device 114 together with, for example, the OS 213 (the print data generation software 202). Thus, the host computer 101 includes the print data generation software 202 and the expansion application 204.

Referring to FIG. 2A, the case where the expansion application 204 is not associated with the print data generation software 202 and the printing apparatus 102 will be described first. A drawing application 201 is a print application (software) that generates a content (print data) to be printed by the printing apparatus 102.

After generating the content, the drawing application 201 can instruct the printing apparatus 102 to print the content. The drawing application 201 is controlled by the OS 213 together with the print data generation software 202 and the expansion application 204. The drawing application 201 is not particularly limited, and may be, for example, a document generation application or a spreadsheet application. The drawing application 201 issues a print instruction to the OS 213 upon receiving a print request from a user via the keyboard 118, for example. The print instruction includes print setting information for instructing operations of the print data generation software 202 and the printing apparatus 102.

The print setting information is also referred to as a “Print Ticket (PT)”. In addition, the drawing application 201 can cause the display unit 119 to display the print setting screen provided by any of the print data generation software 202, the OS 213, and the drawing application 201 in order to output the print setting information. The print setting screen displays setting items indicating settable print functions according to capability information, which is information that can be set as print settings, obtained from the print data generation software 202, and a control items indicating set values thereof. The capability information is also called Print Capabilities (hereinafter, may be referred to as “PC”).

The print data generation software 202 determines the PC on the basis of the print function information 203. The print function information 203 is data indicating all the settable print functions, the set values thereof, and the print functions in which the exclusive relationship between the set values is described. The print function information 203 is also called PDC (Print Device Capabilities). The print function information 203 is included in the configuration file of the print data generation software 202 and is dynamically generated by the print data generation software 202.

Specifically, the print data generation software 202 obtains attribute data of the printing apparatus 102 from the printing apparatus 102. The print data generation software 202 generates the print function information 203 in accordance with attribute information in the attribute data. The “attribute data of the printing apparatus 102” is a response obtained by issuing a “Get-Printer-Attributes” operation of the IPP to the printing apparatus 102. The response includes attribute information (Features) indicating functions that can be designated by the printing apparatus 102, that is, capabilities of the printing apparatus 102, and set values (Options) associated with the attribute information. The response is stored in the RAM 113.

With such a configuration, the print data generation software 202 can provide the user with the print function available in the printing apparatus 102 according to the printing apparatus 102 connected to the print data generation software 202. This enables designation of a print function usable in a printing apparatus regardless of the model of the printing apparatus 102 connected to the print data generation software 202 even when a printing apparatus having a different function or a printing apparatus developed by a different printer manufacturer is connected.

As described below, the print data generation software 202 may be associated with the expansion application 204. This enables the printing apparatus 102 to execute a function that the print data generation software 202 cannot cause the printing apparatus 102 to execute among functions executable by the printing apparatus 102.

The OS 213 generates intermediate data, which may be referred to as “input data”, on the basis of the print instruction output from the drawing application 201, and transmits the intermediate data to the print data generation software 202. A format of the data output for printing by the drawing application 201 is not particularly limited, and is preferably, for example, an XML Paper Specification format (XPS format).

The format of the data output for printing by the drawing application 201 may be a graphic device interface format (GDI format). When the IPP Class Driver is used as the print data generation software 202, if the data output by the drawing application 201 is GDI format data, the OS 213 converts the GDI format data into XPS format data.

Then, the OS 213 transmits the converted XPS format data as the intermediate data to the print data generation software 202. If the data output by the drawing application 201 is XPS format data, the OS 213 transmits the XPS format data to the print data generation software 202 as the intermediate data. The intermediate data includes drawing data that is information about characters and figures to be formed on a print medium and print setting information set by a user.

The print data generation software 202 converts the intermediate data into print data (image data) that can be processed, i.e., printed, by the printing apparatus 102, and transmits the print data (image data) to the printing apparatus 102. Here, the “print data” in this embodiment is Page Description Language (PDL) data conforming to the IPP. The PDL data is, for example, data in a Portable Document Format (PDF) or a PWG-Raster format. The print data includes drawing data that is information about characters and figures to be formed on a print medium, and print setting attribute information that is generated on the basis of the print setting information set by the user and designates the print setting. The print setting attribute information includes attribute information indicating functions that can be designated in the printing apparatus 102, that is, capabilities of the printing apparatus 102, and set values associated with the attribute information.

The printing apparatus 102 prints on a print medium on the basis of the print data transmitted from the print data generation software 202. At this time, the printing apparatus 102 can form the drawing data included in the print data on the print medium by performing an operation according to the print setting attribute information included in the print data. The print setting attribute information includes, for example, print quality such as image quality priority or speed priority, attribute information for designating two-sided printing or one-sided printing, and the set value of the attribute information. For example, when the print setting attribute information includes the attribute information designating the two-sided printing, the printing apparatus 102 can execute two-sided printing.

Referring now to FIG. 2B, a case where the expansion application 204 is associated with the print data generation software 202 and the printing apparatus 102 will be described. As shown in FIG. 2B, the expansion application 204 is added to the configuration in FIG. 2A. That is, the host computer 101 includes the drawing application 201, print data generation software 202, and print function information 203, and further includes the expansion application 204.

The expansion application 204 is software for expanding the function of the print data generation software 202. The expansion application 204 is software that is not included in the OS 213 in advance (not packaged together). Therefore, the expansion application 204 is downloaded from a server (not shown) via the Internet and installed in the host computer 101 by the user operating the host computer 101. Alternatively, the expansion application 204 may be automatically installed in the host computer 101 when the printing apparatus 102 is connected to the host computer 101.

Specifically, when the printing apparatus 102 is connected to the host computer 101, the OS 213 obtains device identification information (hardware ID) from the printing apparatus 102. The OS 213 may download the expansion application 204 corresponding to the device identification information from the server via the Internet and install the expansion application 204. As a result, the print data generation software 202 and the expansion application 204 are held as different control programs in the host computer 101.

The print data generation software 202 and the expansion application 204 may be respectively updated and upgraded. In this case, the update processing of the print data generation software 202 and the update processing of the expansion application 204 may be performed at the same timing or at different timings. A trigger for the host computer 101 to obtain the print data generation software 202 and a trigger for the host computer 101 to obtain expansion application 204 may be the same trigger or different triggers.

When the expansion application 204 is installed, the OS 213 associates the expansion application 204 with the print data generation software 202 and the printing apparatus 102. As shown in FIG. 2B, the expansion application 204 can exchange information (transmit and receive information) with the drawing application 201, the print data generation software 202, and the printing apparatus 102. That is, the expansion application 204 is associated with the drawing application 201, the print data generation software 202, and the printing apparatus 102.

The expansion application 204 includes a print-setting-screen expansion unit 205, a skip controller 206, a print function expansion unit 207, a print data editing unit 208, a notification unit 209, a capability information obtaining unit 211, and an external function providing unit 214. The expansion application 204 includes shared information 210 that can be accessed in common from each of the print-setting-screen expansion unit 205 to the notification unit 209, the capability information obtaining unit 211, and the external function providing unit 214. The shared information 210 is a file stored in the external storage device 114 or information stored in the RAM 113. The expansion application 204 can write and read the shared information 210 by using an Application Program Interface (API) provided by the OS 213.

The expansion application 204 may end the operation of the entire expansion application 204 in accordance with the end of the process of each of the print-setting-screen expansion unit 205 to the notification unit 209, the capability information obtaining unit 211, and the external function providing unit 214. In this case, the OS 213 activates the expansion application 204 whenever a process execution request is received from each unit.

For example, when the process of the print-setting-screen expansion unit 205 is completed, the OS 213 may terminate the operation of the entire expansion application 204. On the other hand, even when the process of the skip controller 206 is completed, the OS 213 may keep the expansion application 204 to activate. The expansion application 204 may cancel the process during the process of each of the print-setting-screen expansion unit 205 to the notification unit 209, the capability information obtaining unit 211, and the external function providing unit 214. In this case, the OS 213 deletes a job in processing on a print queue.

As described above, the drawing application 201 issues a print instruction to the OS 213 in response to a print request from a user. In addition, the drawing application 201 can also display a print setting screen. In the configuration shown in FIG. 2B, the drawing application 201 can display the print setting screen provided by the print-setting-screen expansion unit 205 or display the print setting screen independently of the print-setting-screen expansion unit 205. The screen display can be switched by an operation from the user.

When the drawing application 201 receives a print request from the user and issues a print instruction, the OS 213 activates the skip controller 206. The skip controller 206 performs skip control to skip the process of generating the print data by the print data generation software 202. After the skip control process of the skip controller 206, the OS 213 generates the intermediate print data on the basis of the print instruction output from the drawing application 201. The intermediate print data is transmitted to the print data generation software 202.

For example, when the skip controller 206 does not perform the skip control, the print data generation software 202 processes the intermediate print data into the print data interpretable by the printing apparatus 102 and transmits the print data to the print data editing unit 208. On the other hand, when the skip controller 206 performs the skip control, the intermediate print data is not processed by the print data generation software 202 and is transmitted to the print data editing unit 208. This allows the print data editing unit 208 to process the intermediate print data.

The print data editing unit 208 edits the intermediate print data transmitted from the print data generation software 202 or print data 212 processed by the print data generation software 202. Layout printing is taken as an example of an editing content. The print data editing unit 208 edits the intermediate print data or the print data 212 so that an image in which images of a plurality of pages are laid out on one sheet is output on the basis of the print setting information of the layout printing received from the OS 213.

The print data editing unit 208 can display a UI screen on the display unit 119. Thus, the print data editing unit 208 can display a layout result of the intermediate print data or the print data 212 on the display unit 119 as a preview screen. In a state where the print data editing unit 208 keeps the GUI screen displayed on the display unit 119 opening, the print data 212 is not transmitted to the printing apparatus 102. The transmission process for the print data 212 is executed after closing the GUI screen.

The print data 212 is edited by the print data editing unit 208 and then transmitted to the printing apparatus 102. The printing apparatus 102 performs printing on a recording medium on the basis of the print data 212. Note that, when the skip controller 206 skips the print data generation software 202, the print data editing unit 208 may convert the intermediate print data into the print data interpretable by the printing apparatus 102. Further, a function provided by the OS may be used to convert the intermediate print data into the print data.

The print function expansion unit 207 can edit the print function information 203 (PDC) generated by the print data generation software 202. This enables addition of a function provided by the expansion application 204. Further, a function that can be executed by the printing apparatus 102 but cannot be executed by the print data generation software 202 can be added, and an exclusive relationship between set values of print functions can be added.

The OS 213 activates the print function expansion unit 207 when the expansion application 204 is first associated with the printing apparatus 102 and the print data generation software 202. The OS 213 may activate the print function expansion unit 207 at another timing (for example, at the activation of the OS 213). By such activation, even when the function related to printing is expanded later, the print function expansion unit 207 can detect the expanded function and add the expanded function to the print function information 203. A case where an optional device (for example, a finisher) is added to the printing apparatus 102 later is an example in which the function related to printing is expanded later.

When an error occurs in the printing apparatus 102, the notification unit 209 can notify the user of the error. For example, when a paper out error occurs in the printing apparatus 102, the print data generation software 202 detects the occurrence of the error. The OS 213 causes the display unit 119 to display the occurrence of the paper out error, which is the detection result by the print data generation software 202, as the message by a notification function called a toast notification, which is one of the functions of the OS 213.

When the user operates the toast notification, the notification unit 209 is called by the OS 213 and the user interface screen (UI screen) of the notification unit 209 is displayed. On the user interface screen, for example, a detailed message regarding the paper out error and a paper filling method can be displayed. The configuration of the expansion application 204 is not limited to the configuration having all the functions (units) described above. The expansion application 204 preferably has at least one of the functions, and may have another function.

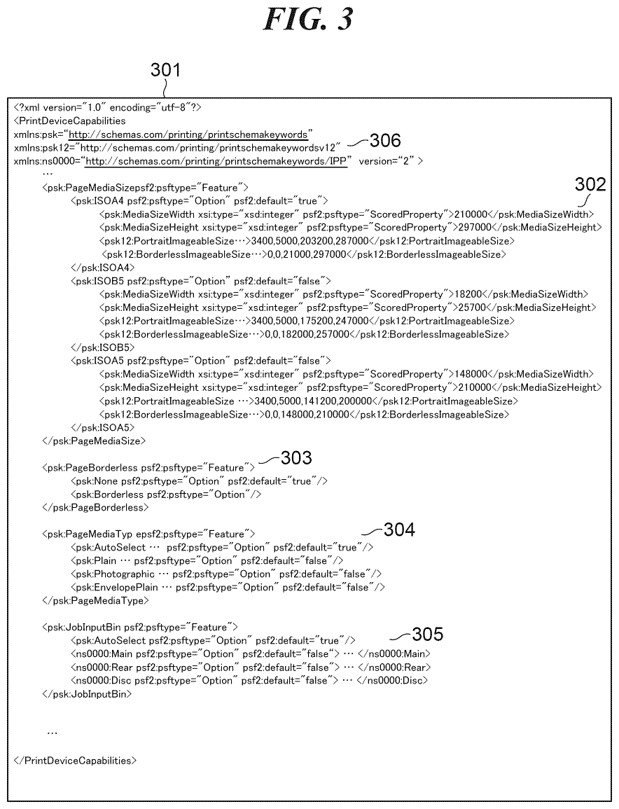

FIG. 3 is a view showing an example of the print function information generated by the print data generation software 202. A script 301 shown in FIG. 3 describes the print function information 203 generated by the print data generation software 202 in an xml format. The script 301 includes pieces of information 302 to 306. The information 306 represents a character string defined as a prefix of a name space to which each Feature or Option described in the information 302 or the information 304 belongs. The “Name Space” represents a set or a range to which each Feature or Option belongs. The Name Space is used to uniquely identify each Feature or Option when the print data generation software 202, the OS 213, or the expansion application 204 refers to the print function information 203, the PT, or the PC.

For example, even if Features or Options are defined by the same name, whether they are defined by the OS 213 or uniquely defined by a vendor can be represented by the Name Space. Specifically, the information 306 shall define that xmlns:psk=“http//schemas.com/printing/printingschemakeywords”. In this case, if “psk” is added as a prefix of each Feature or Option described in the information 302 or the information 303, it can be defined that each Feature or Option belongs to the Name Space described above. If the above-described Name Space is defined in the OS 213, it can be represented that the Feature or Option belongs to the OS 213.

The information 302 indicates that ISOA4, ISOA5, or ISOB5 can be designated as a Page Media Size (sheet size). Here, the Page Media Size indicates a function (Feature), and ISOA4 or the like indicates a set value (Option) for the function, that is, a choice usable for the function. The information 303 indicates that Borderless (without a frame) or None (with a frame) can be set as a Page Borderless setting (borderless print setting). The information 304 indicates that Plain (plain paper), Photographic (photographic paper), or EnvelopePlain (envelop paper) can be designated as a Page Media Type (media). The information 305 indicates that Main (main tray), Rear (rear tray), or Disc (CD/DVD tray) can be designated as Job Input Bin (a sheet feeding method).

The print data generation software 202 or the OS 213 issues a Get-Printer-Attributes operation in the IPP to the printing apparatus 102. Then, the print function information 203 is generated as a response to the operation. The print function information 203 generated here describes the known Features and Options only. In this way, the print function information 203 describes only standard or general-purpose Features and Options among the function information obtained from the printing apparatus 102.

FIGS. 4A, 4B, and 4C are views showing examples of print setting screens displayed by the print-setting-screen expansion unit. In the host computer 101, the PC is generated on the basis of the print function information 203 edited by the print function expansion unit 207. Then, a print setting screen 401A shown in FIG. 4A is displayed on the basis of the PC. The print setting screen 401A includes controls 402 to 409. The print setting screen 401A is not limited to the screen having the configuration shown in FIG. 4A, and may include, for example, other controls different from the controls 402 to 409.

A print setting screen 401B shown in FIG. 4B is a screen in a display state when the control 403 is developed. A print setting screen 401C shown in FIG. 4C is a screen in a display state when the control 404 is developed. The control 402 allows the user to select and set a type of a sheet to be used in printing by the printing apparatus 102. FIG. 4A shows a state where “plain paper” is selected as an example. In the control 402, for example, “auto selection”, “photo paper”, “envelope paper”, or the like can be selected other than “plain paper”.

The control 403 allows the user to select and set a sheet size used in printing in the printing apparatus 102. FIG. 4B shows a state where “A4” is selected as an example. In the control 403, for example, “A5” or the like can be selected other than “A4”. The control 404 allows the user to select a sheet feeding port to be used in printing by the printing apparatus 102. FIG. 4C shows a state where “Auto” (auto select) is selected as an example. In the control 404, for example, “Main tray”, “Rear feed”, or “CD/DVD feed” can be selected other than “Auto”.

The control 405 allows the user to select and set a print orientation in the printing apparatus 102. FIG. 4A shows a state where the orientation of printing in the printing apparatus 102 is set to “Portrait” as an example. In the control 405, “Landscape” can be selected other than “Portrait”.

The control 406 allows the user to enable or disable 2-sided printing. FIG. 4A shows a state where the 2-sided printing is enabled as an example. The control 407 allows the user to select and set a binding direction in the 2-sided printing. FIG. 4A shows a state where “Long-side binding” is set as an example. In the control 407, for example, “Short-side binding” can be set other than “Long-side binding”.

The control 408 is an OK button. When the user operates the OK button, the setting conditions in the controls 402 to 407 can be reflected. After operating the OK button, the print setting screen 401A is closed. The control 409 is a Cancel button. When the user operates the Cancel button, the setting conditions in the controls 402 to 407 are not reflected. After operating the cancel button, the print setting screen 401A is closed.

As described above, the expansion application 204 is intended to expand the function of the print data generation software 202. Therefore, the drawing application 201 cannot directly instruct the expansion application 204 to execute the function of the expansion application 204, and instructs to execute the function of the expansion application 204 via the OS 213.

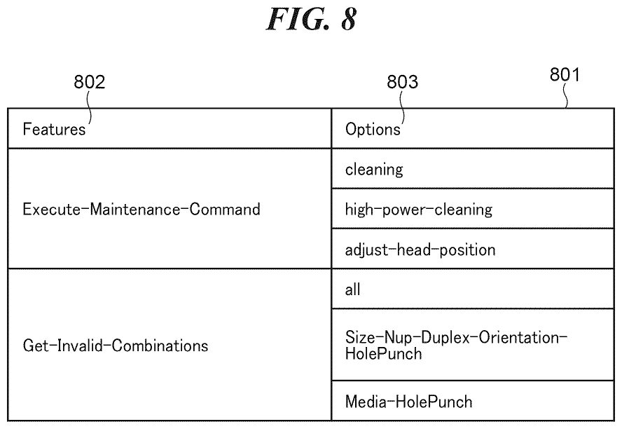

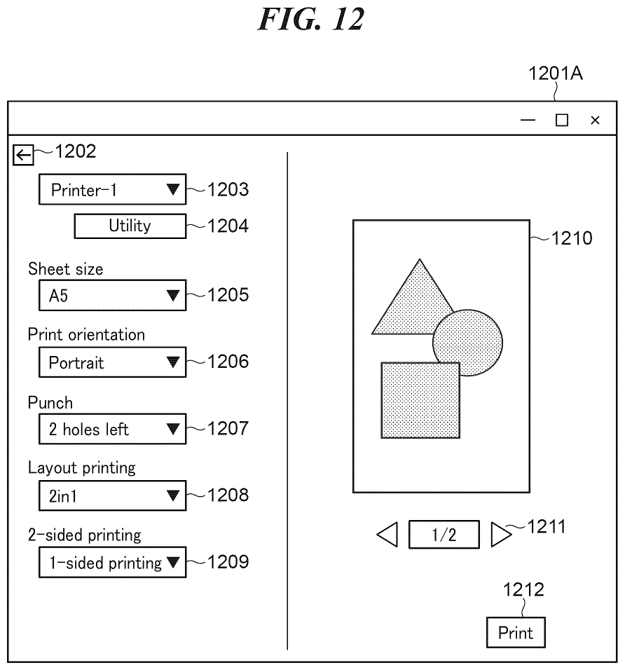

The printing apparatus 102 can execute a plurality of functions, such as a print function, a maintenance function, and a transmission function of prohibition information in printing. The “print function” includes, for example, execution of printing under the conditions in which “Plain paper”, “A4”, “Auto”, “Portrait”, “2-sided printing”, and “Long-side binding” are set on the print setting screen 401A (see FIG. 4A). The “maintenance function” includes “cleaning” for cleaning a print head (see FIG. 8). The “maintenance function” further includes “high-power-cleaning” for strongly cleaning the print head and “adjust-head-position” for adjusting a reference position of the print head (see FIG. 8). The “prohibition information in printing” is information regarding print conditions that cannot be combined at the same time in one print execution. The prohibition in printing is not particularly limited, and examples thereof include a combination of “A5”, “Portrait”, “2 holes left (two punch holes on the left side)”, “2in1 (two pages per sheet)”, and “1-sided printing” (see FIG. 12).

Among these functions that can be executed by the printing apparatus 102, the print data generation software 202 can cause the printing apparatus 102 to perform the print function. In contrast, the print data generation software 202 cannot cause the printing apparatus 102 to perform the maintenance function and the transmission function of prohibition information in printing. Hereinafter, a function that the print data generation software 202 cannot cause the printing apparatus 102 to perform is referred to as a “printer driver inexecutable function”.

The expansion application 204 includes function information related to a printer driver inexecutable function among functions that can be executed by the printing apparatus 102. The drawing application 201 can obtain the function information (an obtaining step) and can instruct the printing apparatus 102 to execute the printer driver inexecutable function by the expansion application 204 on the basis of the function information (an instruction step).

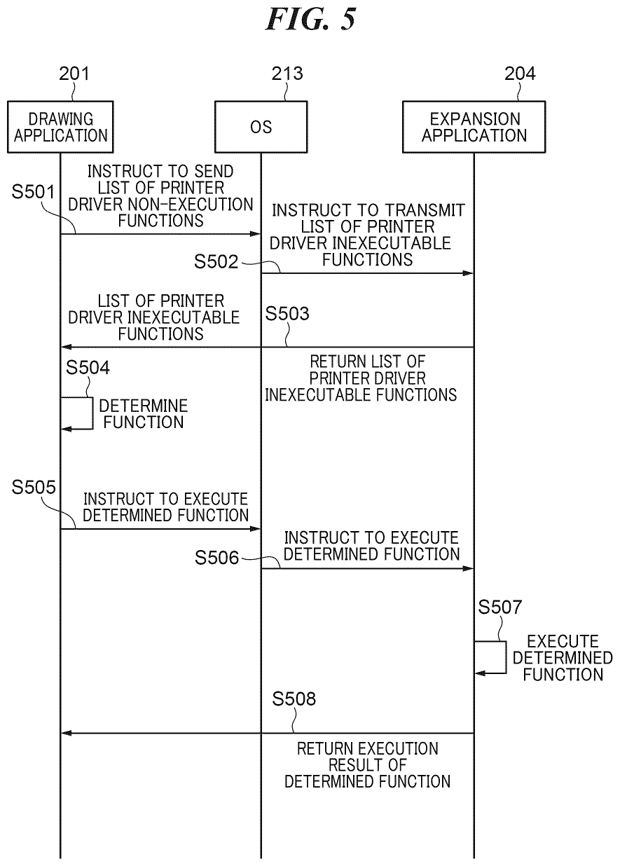

FIG. 5 is a sequence chart showing a process (a printer-driver-inexecutable function execution process) executed between the drawing application, OS, and expansion application. Note that a part of the processes executed by the drawing application 201, a part of the processes executed by the OS 213, and a part of the processes executed by the expansion application 204 may be executed in synchronization (in an overlapping manner). In this case, the processes may be executed synchronously, but are not limited thereto, and may be executed asynchronously (sequentially).

As shown in FIG. 5, in a step S501, the drawing application 201 instructs the OS 213 to transmit a list of the printer driver inexecutable functions as the function information to the expansion application 204. In this way, the drawing application 201 has a function as an instruction means that instructs transmission of the list of the printer driver inexecutable functions before obtaining the list of the printer driver inexecutable functions.

In a step S502, the OS 213 instructs the expansion application 204 to transmit the list of the printer driver inexecutable functions in accordance with the instruction to transmit the list of the printer driver inexecutable functions in the step S501.

In a step S503, the expansion application 204 transmits the list of printer driver inexecutable functions in accordance with the instruction to transmit the list of printer driver inexecutable functions in the step S502. The destination at this time may be the OS 213 or the drawing application 201. When the transmission destination is the OS 213, the drawing application 201 can obtain the list of printer driver inexecutable functions via the OS 213. When the transmission destination is the drawing application 201, the drawing application 201 can directly obtain the list of the printer driver inexecutable functions. In this way, the drawing application 201 has a function as an obtaining unit for obtaining the list of the printer driver inexecutable functions.

In a step S504, the drawing application 201 determines a function (printer driver inexecutable function) that is executed by the printing apparatus 102 at this time from the list of the printer driver inexecutable functions. For example, when the maintenance function and the transmission function of the prohibition information in printing are included in the list of the printer driver inexecutable functions, at least one of them can be determined.

In a step S505, the drawing application 201 instructs the OS 213 to cause the printing apparatus 102 to execute the printer driver inexecutable function determined in the step S504 by the expansion application 204. In this way, the drawing application 201 has a function as an instructing means that instructs the expansion application 204 to execute the printer driver inexecutable function in the printing apparatus 102.

In a step S506, the OS 213 instructs the expansion application 204 to cause the printing apparatus 102 to execute the printer driver inexecutable function in accordance with the instruction to execute the printer driver inexecutable function in the step S505.

In a step S507, the expansion application 204 causes the printing apparatus 102 to execute the printer driver inexecutable function in accordance with the instruction to execute the printer driver inexecutable function in the step S506. Note that a time limit may be set for execution of the printer driver inexecutable function in the printing apparatus 102. For example, if it is determined that a predetermined time (for example, 5 seconds) or more has been spent for execution of the printer driver inexecutable function in the printing apparatus 102, the drawing application 201 or the OS 213 may instruct to stop the execution.

In a step S508, the expansion application 204 outputs and transmits the execution result of the printer driver inexecutable function executed by the printing apparatus 102 in the step S507. The transmission destination at this time may be the OS 213 or the drawing application 201 as with the step S503. When the transmission destination is the OS 213, the drawing application 201 can obtain the execution result from the expansion application 204 via the OS 213. When the transmission destination is the drawing application 201, the drawing application 201 can directly obtain the execution result from the expansion application 204.

As described above, the drawing application 201 has a function as an obtaining means for obtaining the execution result from the expansion application 204. The execution result obtained from the expansion application 204 is preferably the latest execution result. In order to obtain the latest execution result, for example, when the drawing application 201 has already obtained execution results older than the latest execution result, the old execution result may be deleted from the expansion application 204 whenever the latest execution result has been obtained. As a result, the latest execution result is stored in the expansion application 204, and thus the drawing application 201 can obtain the latest execution result.

As described above, the drawing application 201 can cause the printing apparatus 102 to execute even a printer driver inexecutable function that the print data generation software 202 cannot cause the printing apparatus 102 to execute among the functions executable by the printing apparatus 102. Thus, the drawing application 201 can cause the printing apparatus 102 to execute, by the expansion application 204, a function that the printing apparatus 102 can execute but the print data generation software 202 cannot instruct to execute.

Specifically, when the functions executable by the printing apparatus 102 include the print function, maintenance function, and transmission function of prohibition information in printing, the printing data generation software 202 can take charge of the instruction of the print function. On the other hand, the expansion application 204 can take charge of the instruction of the maintenance function and the instruction of the transmission function of prohibition information in printing. The drawing application 201 can execute each function executable by the printing apparatus 102 by such instruction sharing, that is, role sharing.

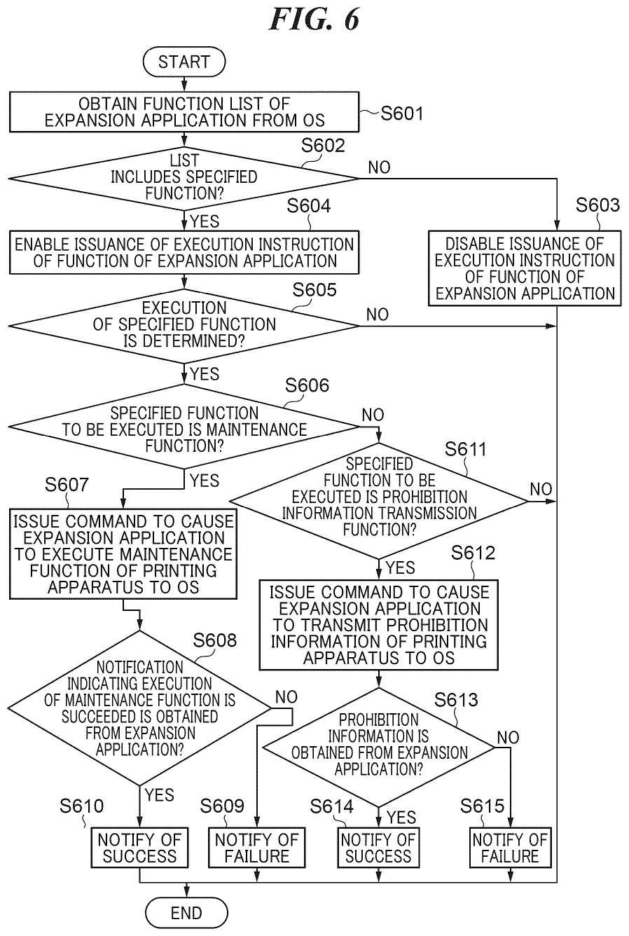

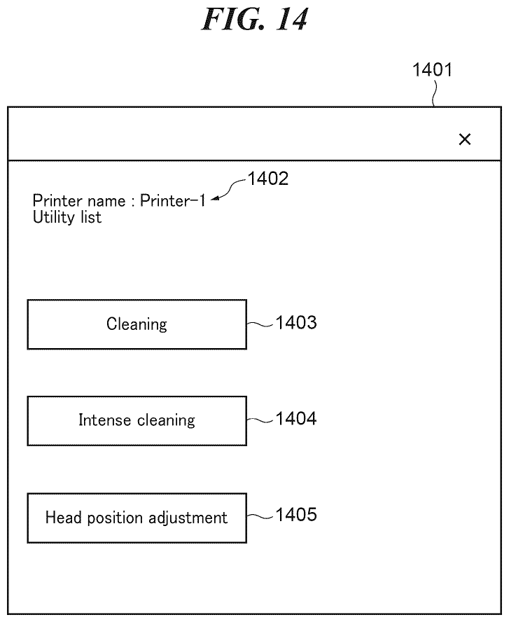

FIG. 6 is a flowchart showing the process performed by the drawing application 201 in the sequence chart shown in FIG. 5. The program based on the flowchart shown in FIG. 6 is started, for example, at a timing when a control 1203 on a print setting screen 1201A shown in FIG. 12 is selected. In addition, the program based on the flowchart shown in FIG. 6 may be started at a timing when a utility screen 1401 shown in FIG. 14 is displayed. As shown in FIG. 6, in a step S601, the drawing application 201 obtains the list of the printer driver inexecutable functions (functions of the expansion application).

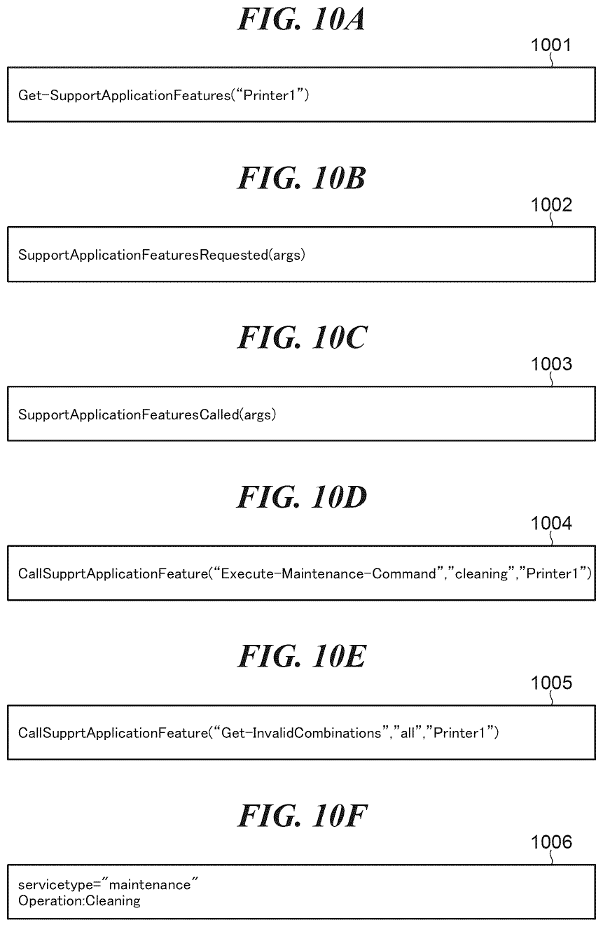

As described above, the list of printer driver inexecutable functions is obtained in accordance with the instruction to transmit the list of the printer driver inexecutable functions. The transmission instruction is performed by executing a command 1001 shown in FIG. 10A described later. An argument “Printer1” included in the command 1001 is a name of a printer queue. The OS 213 that has received the instruction from the drawing application 201 determines the expansion application 204 having the printer driver inexecutable function on the basis of the argument “Printer1”, that is, the name of the printer queue. Then, the OS 213 can instruct the expansion application 204 to transmit the list of the printer driver inexecutable functions. Thus, the drawing application 201 can obtain the list of the printer driver inexecutable functions. Details of the printer driver inexecutable functions will be described later with reference to FIG. 8.

As described above, the drawing application 201 may obtain the list of the printer driver inexecutable functions via the OS 213 or may obtain the list of the printer driver inexecutable functions directly from the expansion application 204. In the case of obtaining via the OS 213, the list of the printer driver inexecutable functions is obtained as a return value from the OS 213. In the case of obtaining directly, the list of the printer driver inexecutable functions is obtained from a path of a file including the list of the printer driver inexecutable functions. The path of the file is the return value from the expansion application 204. The drawing application 201 can obtain the list of the printer driver inexecutable functions by referring to the path of the file, that is, the return value.

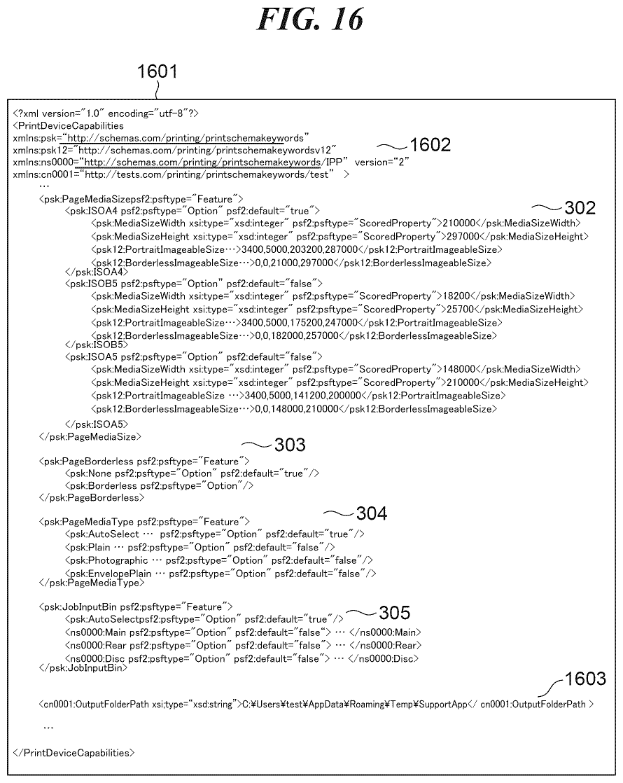

The list of the printer driver inexecutable functions may be stored in the print function information 203 (PDC) (see FIG. 16). The drawing application 201 can detect the path of the file by referring to the capability information (PC) obtained by the print data generation software 202. In this case, the print function expansion unit 207 preferably adds the location (address) of the list of the printer driver inexecutable functions to the print function information 203.

In a step S602, the drawing application 201 determines whether a function (hereinafter, referred to as a “specified function”) that the user wants the printing apparatus 102 to execute this time is included in the list of the printer driver inexecutable functions (functions provided by the expansion application) obtained in the step S601. Here, the specified functions shall be the maintenance function and the transmission function of prohibition information. As a result of the determination in the step S602, when it is determined that the specified function is included, the process proceeds to a step S604. On the other hand, as a result of the determination in the step S602, when it is determined that the specified function is not included, the process proceeds to a step S603. The specified function is designated in advance by the drawing application 201.

In the step S603, the drawing application 201 does not set a specified function permission flag for the expansion application 204, that is, disables issuance of the execution instruction of the specified function of the expansion application 204. Then, the process ends. The “specified function permission flag” indicates whether to permit the instruction to the expansion application 204 to execute the specified function, and is held in the drawing application 201. When the specified function permission flag is not set, a control 1204 is not displayed on the print setting screen 1201A shown in FIG. 12 or is displayed in a gray-out manner. The control 1204 will be described later.

In the step S604, the drawing application 201 sets the specific function permission flag for the expansion application 204, that is, enables issuance of the execution instruction for the function of the expansion application 204.

In a step S605, the drawing application 201 determines whether the execution of the specified function, that is, at least one of the maintenance function and the prohibition information transmission function, is decided. This may be determined on the basis of the specification of the drawing application 201 itself, or may be determined on the basis of an operation from the user on the utility screen 1401 shown in FIG. 14. The maintenance function and the prohibition information transmission function are performed on the basis of Features 802 of information 801 shown in FIG. 8. Then, as a result of the determination in the step S605, when the execution of the specified function is determined, the process proceeds to a step S606. On the other hand, as a result of the determination in the step S605, when the execution of the specified function is not determined, the process ends. In the step S605, execution of Options 803 (see FIG. 8) indicating choices usable in each function included in the Features 802 is also determined.

In step S606, the drawing application 201 determines whether the execution target of the specified function determined in the step S605 is the maintenance function. As a result of the determination in the step S606, when it is determined that it is the maintenance function, the process proceeds to a step S607. On the other hand, as a result of the determination in the step S606, when it is determined that it is not the maintenance function, the process proceeds to a step S611.

In the step S607, the drawing application 201 instructs the OS 213 to execute the maintenance in the printing apparatus 102. The execution of the maintenance is instructed by executing a command 1004, which is shown in FIG. 10D described later, (by issuing the command to the OS) to cause the expansion application to execute the maintenance function of the printing apparatus.

In a step S608, the drawing application 201 determines whether a maintenance execution result (notification) indicating that the execution of the maintenance function in the printing apparatus 102 is succeeded is obtained from the expansion application 204. The maintenance execution result may be obtained via the OS 213 or may be obtained directly from the expansion application 204 as with the step S601. Then, as a result of the determination in the step S608, when it is determined that the result indicating success is obtained, the process proceeds to a step S610. On the other hand, as a result of the determination in the step S608, when it is determined that the result indicating the success is not obtained, the process proceeds to a step S609.

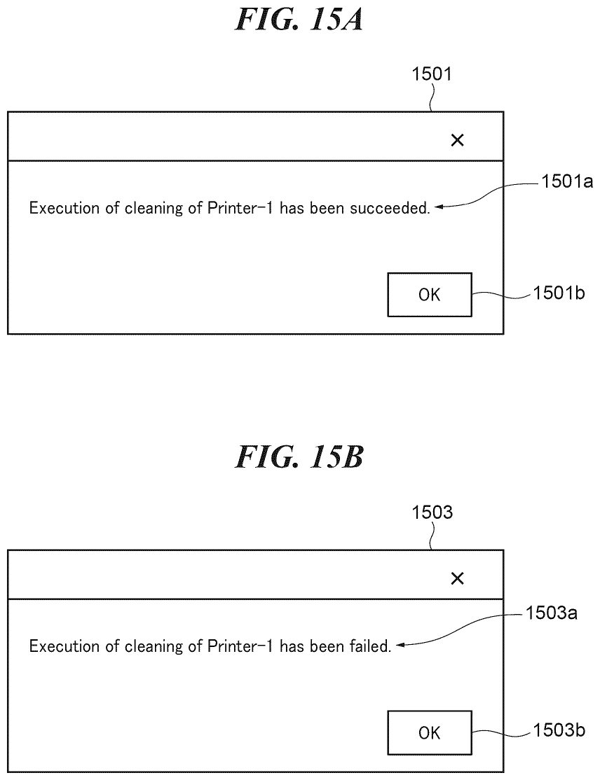

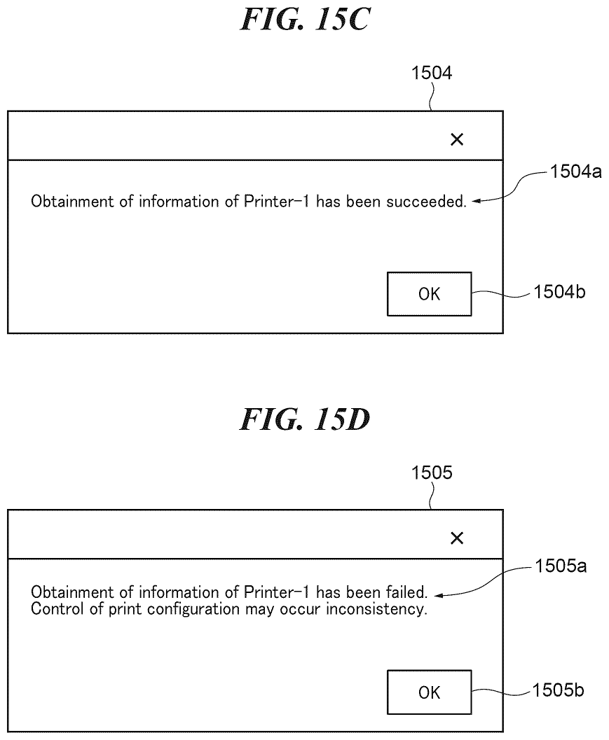

In the step S609, the drawing application 201 displays an execution result screen 1503 shown in FIG. 15B, which will be described later, for notifying the user of the failure of the execution of the maintenance function. Then, the process ends.

In the step S610, the drawing application 201 displays an execution result screen 1501 shown in FIG. 15A, which will be described later, for notifying the user of the success of the execution of the maintenance function. Then, the process ends.

In the step S611, the drawing application 201 determines whether the execution target of the specified function determined in the step S605 is the prohibition information transmission function. As a result of the determination in the step S611, when it is determined that it is the prohibition information transmission function, the process proceeds to a step S612. On the other hand, as a result of the determination in the step S611, when it is determined that it is not the prohibition information transmission function, the process ends.

In the step S612, the drawing application 201 instructs the OS 213 to execute the prohibition information function in the printing apparatus 102. The prohibition information transmission is executed by executing a command 1005, which is shown in FIG. 10E described later, (by issuing the command to the OS) to cause the expansion application to execute the prohibition information transmission function.

In a step S613, the drawing application 201 determines whether the prohibition information is obtained from the expansion application 204 by the prohibition information transmission function. The prohibition information may be obtained via the OS 213 or may be obtained directly from the expansion application 204, as with the step S601. Then, as a result of the determination in the step S613, when it is determined that the prohibition information is obtained, the process proceeds to a step S614.

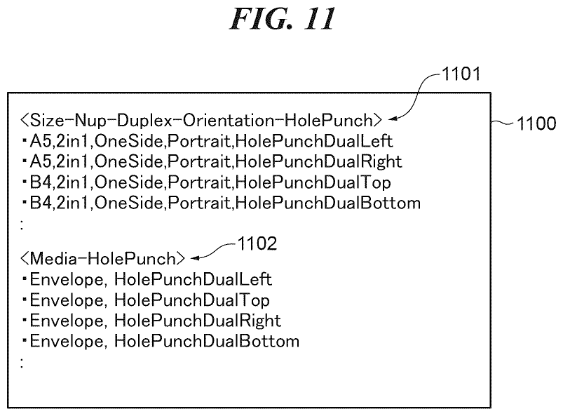

On the other hand, as a result of the determination in the step S613, when it is determined that the prohibition information is not obtained, the process proceeds to a step S615. For example, when the command 1005 (see FIG. 10E) is executed in the step S613, the information about “all” in the Options 803 can be obtained. The information about “all” is all the prohibition information in the printing apparatus 102. The information about “all” is information having a relatively large data amount, and the load during communication becomes high. Therefore, the information about “all” is preferably obtained on the basis of the path of file rather than directly from the expansion application 204. Thus, the information about “all” can be obtained quickly and easily. In addition, for example, when information about “Media-HolePunch” is subjected instead of the information about “all”, second prohibition information 1102 (see FIG. 11) of prohibition information 1100 can be obtained. The second prohibition information 1102 has a smaller data amount than the information about “all”, and therefore, is preferably obtained directly from the expansion application 204.

In the step S614, the drawing application 201 displays an execution result screen 1504 shown in FIG. 15C described later. Then, the process ends.

In the step S615, the drawing application 201 displays an execution result screen 1505 shown in FIG. 15D described later. Then, the process ends.

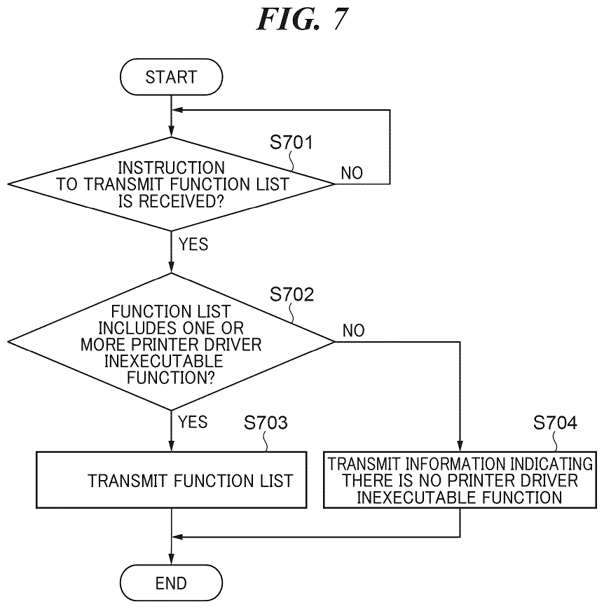

FIG. 7 is a flowchart showing a process (a process for transmitting the list of the printer driver inexecutable functions) executed by the external function providing unit of the expansion application 204 in the sequence chart shown in FIG. 5. The OS 213 activates the external function providing unit 214 by issuing a command 1002 shown in FIG. 10B described later. Information related to the name of the printer queue is designated in an argument “args” included in the command 1002. As shown in FIG. 7, in a step S701, the external function providing unit 214 of the expansion application 204 determines whether an instruction to transmit the list of the printer driver inexecutable functions (functions of the expansion application) from the OS 213 is received, that is, whether there is a transmission instruction. As a result of the determination in the step S701, when it is determined that the transmission instruction is received, the process proceeds to a step S702. On the other hand, as a result of the determination in the step S701, when it is determined that no transmission instruction is received, the process waits in the step S701 as is.

In the step S702, the external function providing unit 214 determines whether the list of the printer driver inexecutable functions includes one or more printer driver inexecutable functions. The list of the printer driver inexecutable functions is stored in the shared information 210 (see FIG. 2B) as the information 801 shown in FIG. 8. The determination in the step S702 is performed by the external function providing unit 214 referring to the information 801. Then, as a result of the determination in the step S702, when it is determined that one or more printer driver inexecutable functions are included, the process proceeds to a step S703. On the other hand, as a result of the determination in the step S702, when it is determined that no printer driver inexecutable function is included in the list of the printer driver inexecutable functions, the process proceeds to a step S704.

In the step S703, the external function providing unit 214 transmits the information 801 (the list of the printer driver inexecutable functions). The information 801 may be transmitted in the format shown in FIG. 8 or in a format interpretable by the drawing application 201. As described above, the transmission destination at this time may be the OS 213 or the drawing application 201.

In the step S704, the external function providing unit 214 transmits information indicating that no printer driver inexecutable function is included. Note that this information may include the character string “NONE”, for example, and may be transmitted in the format interpretable by the drawing application 201. Also, the destination at this time may be the OS 213 or the drawing application 201, as with the step S703.

FIG. 8 is a view showing an example of the list of the printer driver inexecutable functions. The information 801 shown in FIG. 8 includes the Features 802 indicating the printer driver inexecutable functions and the Options 803 indicating choices usable by each function included in the Features 802. Note that the Features 802 and the Options 803 included in the information 801 depend on the type (model) of the printing apparatus 102. The Features 802 include “maintenance function (Execute-Maintenance-Command)” and “prohibition information in printing (Get-Invalid-Combinations)”. The “maintenance function” includes the above-described “cleaning”, “high-power-cleaning”, and “adjust-head-position” as the Options 803. The user can select at least one of these Options 803.

The “prohibition information in printing” includes “all”, “Size-Nup-Duplex-Orientation-HolePunch”, and “Media-HolePunch” as the Options 803. The “all” means all print condition groups that cannot be combined simultaneously in one printing execution. The “Size-Nup-Duplex-Orientation-HolePunch” means print condition groups each of which includes a sheet size, a print orientation, punch holes, layout printing, and 2-sided/1-sided printing that cannot be simultaneously combined in one printing execution. The “Media-HolePunch” means print condition groups each of which includes a sheet type and punch holes that cannot be simultaneously combined in one printing execution.

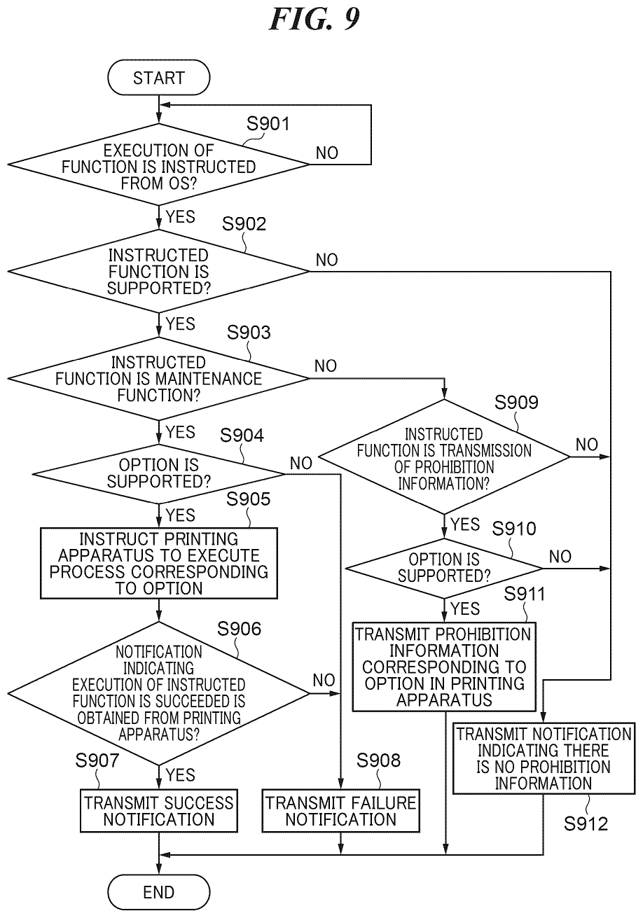

FIG. 9 is a flowchart showing a process (a process for executing a printer driver inexecutable function) executed by the external function providing unit of the expansion application in the sequence chart shown in FIG. 5. The program based on the flowchart shown in FIG. 9 is started, for example, at a timing when the drawing application 201 executes the command 1004 (see FIG. 10D) or the command 1005 (see FIG. 10E). The OS 213 activates the external function providing unit 214 by executing a command 1003 in FIG. 10C, which will be described later. Information regarding the name of the printer queue, information regarding the Features 802 and the Options 803, and the like are designated in the argument “args” included in the command 1003.

As shown in FIG. 9, in a step S901, the external function providing unit 214 of the expansion application 204 determines whether there is an instruction from the OS 213 to cause the printing apparatus 102 to execute a printer driver inexecutable function, that is, whether there is an instruction from the OS 213. As a result of the determination in the step S901, when it is determined that an instruction is given from the OS 213, the process proceeds to a step S902. On the other hand, as a result of the determination in the step S901, when it is determined that no instruction is given from the OS 213, the process waits in the step S901 as is.

In the step S902, the external function providing unit 214 determines whether the instructed function is supported on the basis of whether the information designated by the argument “args” included in the command 1003 is supported. This may be determined on the basis of whether the information designated by the argument “args” is included in the table 801. Then, as a result of the determination in the step S902, when it is determined that the information designated by the argument “args” is supported, the process proceeds to a step S903. On the other hand, as a result of the determination in the step S902, when it is determined that the information designated by the argument “args” is not supported, the process proceeds to a step S912.

In the step S903, the external function providing unit 214 determines whether the information designated by the argument “args” indicates execution of the maintenance function. As a result of the determination in the step S903, when it is determined that the information indicates the execution of the maintenance function, the process proceeds to a step S904. On the other hand, as a result of the determination in the step S903, when it is determined that the information does not indicate the execution of the maintenance function, the process proceeds to a step S909.

In the step S904, the external function providing unit 214 determines whether the information designated by the argument “args” supports the information of the Options 803 of the maintenance function. This may be determined on the basis of whether the information designated by the argument “args” is included in the table 801. Then, as a result of the determination in the step S904, when it is determined that the designated information supports the information of the Options 803, the process proceeds to a step S905. On the other hand, as a result of the determination in the step S904, when it is determined that the designated information does not support the information of the Options 803, the process proceeds to a step S908.

In the step S905, the external function providing unit 214 instructs the printing apparatus 102 to execute at least one of “cleaning” and the like included in the Options 803 of the maintenance function. Thus, the execution is performed in the printing apparatus 102. The execution is instructed in the step S905 by transmitting a command 1006 shown in FIG. 10F to the printing apparatus 102.

In a step S906, the external function providing unit 214 determines whether a result (notification) indicating that the execution instructed in the step S905 is succeeded in the printing apparatus 102 is obtained from the printing apparatus 102. As a result of the determination in the step S906, when it is determined that the result indicating success is obtained, the process proceeds to a step S907. On the other hand, as a result of the determination in the step S906, when it is determined that the result indicating the success is not obtained, the process proceeds to the step S908.

In the step S907, the external function providing unit 214 transmits a success notification (for example, “Execute-Maintenance-Command”, “cleaning”: Succeeded). Then, the process ends. The destination at this time may be the OS 213 or the drawing application 201.

In the step S908, the external function providing unit 241 transmits a failure notification (for example, “Execute-Maintenance-Command”, “cleaning”: Failed). Then, the process ends. The destination at this time may be the OS 213 or the drawing application 201 as with the step S907.

In the step S909, the external function providing unit 214 determines whether the information designated by the argument “args” indicates the prohibition information transmission function. As a result of the determination in the step S909, when it is determined that the designated information indicates the prohibition information transmission function, the process proceeds to a step S910. On the other hand, as a result of the determination in the step S909, when it is determined that the information does not indicate the prohibition information transmission function, the process proceeds to the step S912.

In the step S910, the external function providing unit 214 determines whether the information designated by the argument “args” supports the information of the Options 803 of the prohibition information transmission function. This may be determined on the basis of whether the information designated by the argument “args” is included in the table 801. Then, as a result of the determination in the step S910, when it is determined that the information of the Options 803 is supported, the process proceeds to a step S911. On the other hand, as a result of the determination in the step S910, when it is determined that the designated information does not support the information of the Options 803, the process proceeds to the step S912.

In the step S911, the external function providing unit 214 executes the prohibition information transmission function. Then, the process ends. The destination at this time may be the OS 213 or the drawing application 201 as with the step S907.

In step S912, external function providing unit 214 transmits the fact that there is no prohibition information supporting the Options 803 (for example, “Get-InvalidCombinations”, “Size-Media”: Failed). Then, the process ends. The destination at this time may be the OS 213 or the drawing application 201 as with the step S907.

FIGS. 10A to 10F are views showing examples of commands executed by the drawing application, the OS, and the expansion application, respectively. The command 1001 shown in FIG. 10A is a command executed when the drawing application 201 obtains the list of the printer driver inexecutable functions. As described above, the argument “Printer1” included in the command 1001 is the name of the printer queue.

The command 1002 shown in FIG. 10B is a command that the OS 213 instructs the expansion application 204 to transmit the list of the printer driver inexecutable functions when the command 1001 is executed. As described above, the argument “args” included in the command 1002 designates the information about the name of the printer queue. The command 1003 shown in FIG. 10C is a command that the OS 213 instructs the expansion application 204 to execute the printer driver inexecutable function when the command 1004 or 1005 is executed. The argument “args” included in the command 1003 designates the information related to the names of the Features 802, the names of the Options 803, and the name of the printer queue.

The command 1004 shown in FIG. 10D is a command that the drawing application 201 instructs the OS 213 to execute the “cleaning” of the Options 803 in the printing apparatus 102 by the expansion application 204. The command 1005 shown in FIG. 10E is a command that the drawing application 201 instructs the OS 213 to execute transmission of “all” of the Options 803 by the expansion application 204. The command 1006 shown in FIG. 10F is a command that the external function providing unit 214 instructs the printing apparatus 102 to execute the “cleaning” of the Options 803.

FIG. 11 is a view showing an example of the prohibition information held by the expansion application 204. The prohibition information 1100 shown in FIG. 11 may be held in advance or may be obtained once from an external server holding the prohibition information 1100 and then held. The prohibition information 1100 includes first prohibition information 1101 and second prohibition information 1102.

The first prohibition information 1101 includes a plurality of pieces of information related to “Size-Nup-Duplex-Orientation-HolePunch”. The “Size-Nup-Duplex-Orientation-HolePunch” defines a prohibited combination of a sheet size, layout printing, 2-sided/1-sided printing, print orientation, and punch holes. The first prohibition information 1101 includes, for example, “A5, 2in1, OneSide, Portrait, HolePunchDualLeft”. This indicate that the combination of “A5”, “2in1 (2 pages per one side)”, “Portrait”, and “Two holes at left (two punch holes at left side)” is prohibited.

The second prohibition information 1102 includes a plurality of pieces of information related to “Media-HolePunch”. The “Media-HolePunch” defines a prohibited combination of a sheet type and punch holes. The second prohibition information 1102 includes “Envelope, HolePunchDualLeft”, for example. This indicates that a combination of “envelope sheet” and “two holes left” is prohibited.

FIG. 12 is a view showing an example of a print setting screen used by the drawing application 201. As shown in FIG. 12, the print setting screen 1201A includes controls 1202 to 1209, a preview area 1210, a control 1211, and a control 1212. The print setting screen 1201A is not limited to the screen having the configuration shown in FIG. 12, and may include, for example, controls other than the controls 1202 to 1209.

The control 1202 is a screen transition button, and an operation of the screen transition button transitions from the print setting screen 1201A to a print data editing screen. The print data editing screen may be, for example, a screen used by the drawing application 201 capable of document editing and image processing, or may be a screen for selecting a print target.

The control 1203 is used to select and set the printing apparatus 102 used for printing. In FIG. 12, “printer-1” is selected and set as an example of the printing apparatus 102. When the predetermined printing apparatus 102 is selected and set by using the control 1203, the program is executed on the basis of the flowchart shown in FIG. 6.

When the expansion application 204 has the maintenance function, the control 1204 is displayed. The control 1204 is a screen display button, and the utility screen 1401 (see FIG. 14) can be displayed by operating the screen display button. When the prohibition information in the printing apparatus 102 selected by the control 1203 can be obtained, the execution result screen 1504 (see FIG. 15C) or the execution result screen 1505 (see FIG. 15D) is displayed according to the obtaining result. Note that the execution result screen 1504 or the execution result screen 1505 is preferably displayed so as to overlap the print setting screen 1201A, but this is not limiting. For example, the execution result screen may be displayed after temporarily closing the print setting screen 1201A.

The control 1205 is used to select and set the sheet size used in printing in the printing apparatus 102. In FIG. 12, “A5” is selected as an example. The control 1206 is used to select and set the print orientation in the printing apparatus 102. In FIG. 12, the orientation of printing in the printing apparatus 102 is set to “Portrait” as an example. The control 1207 is used to select and set the position and the number of punch holes to be punched in the printed matter. In FIG. 12, the position of the punch holes is set to “left” and the number of punch holes is set to “two” as an example. The control 1208 is used to select and set the layout per one page of a sheet. In FIG. 12, “2in1 (2 pages/sheet)” is set as an example.

The control 1209 is used to select and set whether the printing apparatus 102 performs 2-sided printing or 1-sided printing. In FIG. 12, “1-sided printing” is set as an example. In the preview area 1210, a preview image to be printed that has been edited or processed by the drawing application 201 is displayed. The control 1211 includes a pair of switching buttons for switching preview images when there are a plurality of preview images displayed in the preview area 1210. By operating the switching buttons, the preview image can be returned in order or advanced in order.

The control 1212 is a print execution button that instructs execution of printing by the printing apparatus 102. By operating the print execution button, the printing apparatus 102 prints a printed matter including the preview image displayed in the preview area 1210.

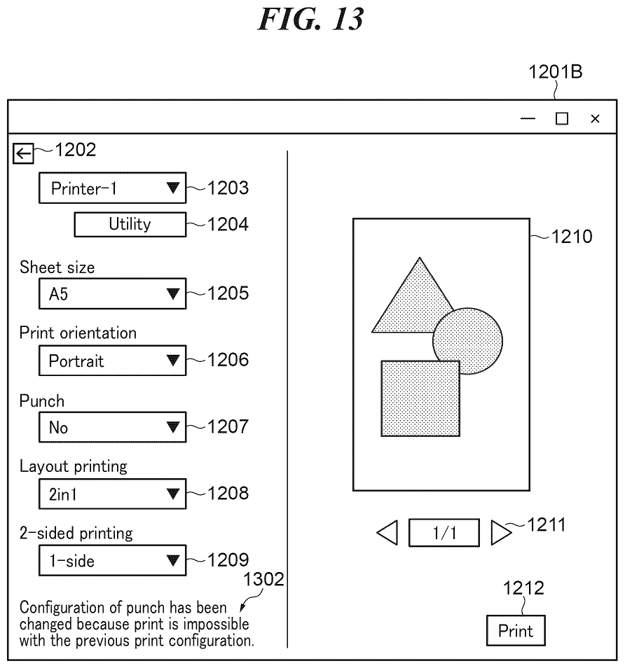

FIG. 13 is a view showing a state where a prohibition cancellation process is executed on the print setting screen shown in FIG. 12. The settings of the controls 1205 to 1209 in the print setting screen 1201A shown in FIG. 12 match the prohibited combination based on the first prohibition information 1101. That is, the settings of the controls 1205 to 1209 are the same combination as “A5, 2in1, OneSide, Portrait, HolePunchDualLeft” included in the first prohibition information 1101.

The drawing application 201 can detect the settings of the controls 1205 to 1209 in the print setting screen 1201A. Then, when it is determined that the result of the detection is the same combination as the prohibition based on the first prohibition information 1101, the prohibition cancellation process is executed, and the print setting screen 1201A shown in FIG. 12 is forcibly changed to the print setting screen 1201B shown in FIG. 13.

Specifically, the setting “2 holes left” in the control 1207 in the print setting screen 1201A is changed to the setting “No” in the control 1207 in the print setting screen 1201B. The change of the setting in the control 1207 is not limited to the forcible change. For example, a message for prompting the user to change the setting in the control 1207 may be displayed once. And the setting in the control 1207 may be changed when the change according to the message is permitted by an operation from the user.

As shown in FIG. 13, the print setting screen 12B includes a message 1302. As described above, the drawing application 201 can detect the settings of the controls 1205 to 1209 in the print setting screen 1201A. The message 1302 is displayed when the setting in the control 1207 in the print setting screen 1201B is changed as a result of the determination that the result of the detection indicates that the combination is the same as the prohibited combination based on the first prohibition information 1101.

FIG. 14 is a view showing an example of a utility screen. The utility screen 1401 shown in FIG. 14 is displayed by operating the control 1204 on the print setting screen 1201A. The utility screen 1401 includes a message 1402 and controls 1403 to 1405.

The message 1402 indicates that the controls 1403 to 1405 are used to instruct execution of the maintenances that can be performed in the printing apparatus of which the name is “printer-1” that is selected in the control 1203 on the print setting screen 1201A. The control 1403 is used to instruct execution of the “cleaning” included in the Options 803 of the information 801 shown in FIG. 8. The user can instruct the expansion application 204 to execute the “cleaning” of the print head, which is one of the maintenance functions, via the OS 213 by operating the control 1403.

The control 1404 is used to instruct execution of the “high-power-cleaning” included in the Options 803. The user can instruct the expansion application 204 to execute the “high-power-cleaning” of the print head, which is one of the maintenance functions, via the OS 213 by operating the control 1404. The control 1405 is used to instruct execution of the “adjust-head-position” included in the Options 803. The user can instruct the expansion application 204 to execute the “adjust-head-position”, which is one of the maintenance functions, via the OS 213 by operating the control 1405.

After operating any one of the controls 1403 to 1405, the execution result of the maintenance function instructed by the control operated is displayed. For example, after operating the control 1403, the execution result screen 1501 shown in FIG. 15A or the execution result screen 1503 shown in FIG. 15B is displayed as the execution result of the maintenance function.

FIGS. 15A to 15D are views showing examples of displaying maintenance execution results. An execution result screen 1501 shown in FIG. 15A includes a message 1501a and a control 1501b. The message 1501a indicates that the maintenance execution after the operation of the control 1403, that is, the execution of cleaning of the print head has been succeeded. The control 1501b is an OK button, and the execution result screen 1501 can be closed by operating the OK button.

An execution result screen 1503 shown in FIG. 15B includes a message 1503a and a control 1503b. The message 1503a indicates that the maintenance execution after the operation of the control 1403, that is, the execution of the cleaning of the print head has been failed. The control 1503b is an OK button, and the execution result screen 1503 can be closed by operating the OK button. The user can understand whether the execution of the cleaning has been succeeded or not by watching the execution result screen 1501 or the execution result screen 1503.

An execution result screen 1504 shown in FIG. 15C includes a message 1504a and a control 1504b. The message 1504a indicates that the obtainment of the prohibition information has been succeeded when the expansion application 204 transmits the prohibition information in the case where the “printer-1” is selected in the control 1203 on the print setting screen 1201. The control 1504b is an OK button, and the execution result screen 1504 can be closed by operating the OK button.

An execution result screen 1505 shown in FIG. 15D includes a message 1505a and a control 1505b. The message 1505a indicates that the obtainment of the prohibition information has been failed when the expansion application 204 transmits the prohibition information in the case where the “printer-1” is selected in the control 1203 on the print setting screen 1201.

The message 1505a also includes a message indicating that the settings in the controls 1205 to 1209 on the print setting screen 1201 match the prohibited combination. The control 1505b is an OK button, and the execution result screen 1505 can be closed by operating the OK button. The user can understand whether the obtainment of the prohibition information has been succeeded or not by watching the execution result screen 1504 or the execution result screen 1505.

FIG. 16 is a view showing an example of print function information generated by the print function expansion unit. A script 1601 shown in FIG. 16 describes the print function information 203 generated by the print function expansion unit 207 in the xml format. The script 1601 includes information 1602 and information 1603 in addition to the pieces of information 302 to 306 as in the information 301 shown in FIG. 3.

The information 1602 is related to the path of the file that is referred to when the drawing application 201 obtains the list of the printer driver inexecutable functions. For example, “xmlns:cn0001=http://tests.com/printing/printschemakeywords/test” means that the attribute of the file path belongs to a space defined by cn0001. The information 1603 indicates the location of the area for temporarily storing the file in which the list of the printer driver inexecutable functions requested by the drawing application 201, the maintenance execution result, and the like are stored. Such a script 1601 can be used in the process of executing the maintenance function or in the process of transmitting the prohibition information.

Although the preferred embodiments of the present invention have been described above, the present invention is not limited to the above-described embodiments, and various modifications and changes can be made within the scope of the gist of the present invention. The present invention can also be achieved by one or more processors of a computer of a system or an apparatus reading and executing a program that achieves one or more functions of the above-described embodiments and is provided to the system or the apparatus via a network or a storage medium. The present invention can also be implemented by a circuit (for example, an ASIC) that implements one or more functions.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-014879, filed Feb. 2, 2024, which is hereby incorporated by reference herein in its entirety.

What is claimed is:

1. A non-transitory computer-readable storage medium storing a print application that can execute a print instruction, and is used together with a standard driver capable of transmitting print data to printing apparatuses of manufacturers, an expansion application, and an operating system controlling the standard driver, the expansion application, and the print application,
wherein the print application comprises:
obtaining function information regarding a printer driver inexecutable function that the standard driver cannot cause a printing apparatus to execute, among functions executable by the printing apparatus, from the expansion application; and
instructing the operating system to cause the printing apparatus to execute the printer driver inexecutable function based on the function information by the expansion function.

2. The non-transitory computer-readable storage medium according to claim 1, wherein the print application instructs the operating system to cause the expansion application to transmit the function information prior to obtainment of the function information in obtaining the function information.

3. The non-transitory computer-readable storage medium according to claim 1, wherein the print application instructs the operating system to cause the expansion application to execute the printer driver inexecutable function in the printing apparatus.

4. The non-transitory computer-readable storage medium according to claim 1, wherein the print application obtains a list of printer driver inexecutable functions as the function information.

5. The non-transitory computer-readable storage medium according to claim 1, wherein the print application is capable of obtaining an execution result of causing the printing apparatus to execute the printer driver inexecutable function output by the expansion application.

6. The non-transitory computer-readable storage medium according to claim 1, wherein the printer driver inexecutable function includes at least one of a maintenance function and a prohibition information transmission function.

7. An information processing apparatus comprising:
a standard driver capable of transmitting print data to printing apparatuses of manufacturers;
an expansion application;
a print application capable of executing a print instruction; and
an operating system capable of controlling the standard driver, the expansion application, and the print application,
wherein the expansion application includes function information regarding a printer driver inexecutable function that the standard driver cannot cause a printing apparatus to execute, among functions executable by the printing apparatus, and
wherein the print application comprises:
obtaining the function information from the expansion application; and
instructing the operating system to cause the printing apparatus to execute the printer driver inexecutable function based on the function information by the expansion function.

8. The information processing apparatus according to claim 7, wherein the print application instructs the operating system to cause the expansion application to transmit the function information prior to obtainment of the function information in obtaining the function information.

9. The information processing apparatus according to claim 7, wherein the print application instructs the operating system to cause the expansion application to execute the printer driver inexecutable function in the printing apparatus.

10. The information processing apparatus according to claim 7, wherein the print application obtains a list of printer driver inexecutable functions as the function information.

11. The information processing apparatus according to claim 7, wherein the print application is capable of obtaining an execution result of causing the printing apparatus to execute the printer driver inexecutable function output by the expansion application.

12. The information processing apparatus according to claim 7, wherein the printer driver inexecutable function includes at least one of a maintenance function and a prohibition information transmission function.

13. A control method for an information processing apparatus including a standard driver capable of transmitting print data to printing apparatuses of manufacturers, an expansion application, a print application capable of executing a print instruction; and an operating system capable of controlling the standard driver, the expansion application, and the print application, the control method comprising:
the print application obtaining function information regarding a printer driver inexecutable function that the standard driver cannot cause a printing apparatus to execute, among functions executable by the printing apparatus, from the expansion application; and
the print application instructing the operating system to cause the printing apparatus to execute the printer driver inexecutable function based on the function information by the expansion function.

14. The control method for the information processing apparatus according to claim 13, wherein the print application instructs the operating system to cause the expansion application to transmit the function information prior to obtainment of the function information in obtaining the function information.

15. The control method for the information processing apparatus according to claim 14, wherein the operating system is capable of transmitting the function information to the expansion application according to an instruction to transmit the function information.

16. The control method for the information processing apparatus according to claim 15, wherein the expansion application is capable of transmitting the function information.

17. The control method for the information processing apparatus according to claim 13, wherein the print application instructs the operating system to cause the expansion application to execute the printer driver inexecutable function in the printing apparatus.

18. The control method for the information processing apparatus according to claim 17, wherein the operating system is capable of causing the expansion application to execute the printer driver inexecutable function in the printing apparatus according to an instruction to cause the printing apparatus to execute the printer driver inexecutable function.

19. The control method for the information processing apparatus according to claim 18, wherein the expansion application is capable of causing the printing apparatus to execute the printer driver inexecutable function.

20. The control method for the information processing apparatus according to claim 13, wherein the print application obtains a list of printer driver inexecutable functions as the function information.

21. The control method for the information processing apparatus according to claim 13, wherein the expansion application is capable of outputting an execution result of causing the printing apparatus to execute the printer driver inexecutable function.

22. The control method for the information processing apparatus according to claim 21, wherein the print application is capable of obtaining the execution result.

23. The control method for the information processing apparatus according to claim 13, wherein the printer driver inexecutable function includes at least one of a maintenance function and a prohibition information transmission function.
